(19) United States
(12) Patent Application Publication
(10) Pub. No.: US 2014/0365601 A1
(43) Pub. Date: Dec. 11, 2014

(54) Computer, Phone, and Mobile Communication, and Emission, of Scent

(71) Applicant: Sivatharan Natkunanathan, Irvine, CA (US)

(72) Inventor: Sivatharan Natkunanathan, Irvine, CA (US)

(21) Appl. No.: 13/815,941

(22) Filed: Mar. 18, 2013

(51) Int. Cl. H04L 29/08

(52) U.S. Cl. CPC H04L 67/02
USPC 709/217

(57) ABSTRACT

A system or process for communication, and emission, of scent, by means of a standalone or networked computer, a phone, a scent-device comprising a “ScentDEV”, and a mobile personal scent device or “Mobile ScentDEV”, is the subject of this invention. The said system or process enables communication of the additional element of scent, and communication and emission of scent by means of a scent-device comprising a “ScentDEV” or a Mobile ScentDEV. Scent information on a machine-device OS, program, or application, is communicated to a ScentDEV in connection thereto, for performance emission of scent therefrom, with means comprising of a ScentDEV driver.

A related invention is a mobile personal scent device or Mobile ScentDEV, comprising mechanical, electro-mechanical, or electrical user controls. The said device is operability controlled by a user or client, comprising means for activation, deactivation, and operational timing of said device. The said Mobile ScentDEV is a consumer product.

### BACKGROUND OF THE INVENTION

The idea for this invention was materialized during the days of communicating by means of, e-mail with a networked computer, and a conventional, cellular, and internet phone. A user or client communicates, by means of the internet, elements comprising: text, hyperlink, and still image by means of a web page; text, hyperlink, and document attachments by means of an e-mail program or application; text by means of a text chat program or application; and voice or sound by means of a phone program or application. Similarly, a user or client communicates, voice or sound, by means of a phone. The said means present to a user or client, limited elements in communication, in comparison to elements naturally communicated during real-life events.

The quality of communication, by said electronic means, is far removed from real-life events, as compared to an in-person, or face to face, presentation or appearance. The solution therefore, comprises enhancements in systems, and processes, for communicating elements that stimulate the human physiological senses during a real-life event. However, even when communication by means of a computer or phone is cumbersome in performance output of elements perceived during real-life events, the communication system or process of this invention, presents to a user or client, communication elements for the perception of real-life events, with means of the physiological senses of said user or client.

This invention pertains to communication, and emission, of “scent”, referred to previously as “smell”, for the perception of scent by a user or client, comprising in electronic communication, and emission. The element of scent, when communicated by means of a computer or phone, means with standalone or network communication, presents to a said user or client, the additional element of scent in said electronic communications.

The system or process for scent communication, and emission, by said means, is referred to herein as “ScentCOM”, which is an enhancement in communications. The said ScentCOM system or process for communication, and emission, of scent, enhances the performance output scent element effects to the quality of real-life events.

The ScentCOM system or process comprises of two, interdependent sub-systems, and sub-processes, one that consists of scent communication, and the other that consists of scent emission. The said system or process, detailed herein individually, and as a unitary whole, presents the fundamentals for communication, and emission, of scent by said means.

A standalone or networked computer, and a phone, performs communication, and emission, of scent, by means of a connection to a scent device, apparatus, or machine. The said scent device, apparatus, or machine, is referred to herein, as a device, namely a “ScentDEV”.

Another related invention presented herein, is a mobile personal scent device, apparatus, or machine, for scent communication, and emission. The said device employs the means of the ScentCOM system or process for communication, and emission, of scent. The said mobile personal scent device, apparatus, or machine, is referred to herein, as a device, namely a “Mobile ScentDEV”. The said Mobile ScentDEV presents to a user or client, emission of fresh scent, by means of a compact, lightweight, and user or client controlled scent device.

For purposes of simplicity, the ScentDEV, and the Mobile ScentDEV, device, apparatus, or machine, is referred to herein, as a ScentDEV device, and a Mobile ScentDEV device, respectively. As defined herein, the word “scent”, alternatively refers to smell, odor, fragrance, cologne, perfume, incense, or variations thereof.

1. Introduction

The scope of this invention is communication, and emission, of scent by means of (1) a standalone or networked computer, or (2) a phone, and communication and emission of scent by means of (3) a scent device, namely, a ScentDEV, or (4) a mobile personal scent device, namely, a Mobile ScentDEV.

The word “machine-device” as defined herein, consists of, a standalone or networked computer, or a phone. The word “machine”, as defined herein, consists of a device, apparatus, or machine.

The system or process for communication, and emission, of scent, by means of a said “machine-device” (1, and 2 hereinabove), or a said “scent-device” (3, and 4 hereinabove), is referred to herein, as “ScentCOM”.

2. Description of Prior Art

Prior art relating to scent communication, by means of electronic devices, is minimal or non-existent. Some examples of prior art, relating to scent emission are described herein.

Prior art relating to scent emission, is the use of liquid or gaseous scent substances, from a receptacle, canister, or petite container, comprising a power source, for flavoring the surrounding atmosphere with scent. Another prior art, is emission of incense with smoke, or fire.

The fundamental prior art is emission of scent from a natural source, and designed prior art is emission of scent from a designed, developed, or manufactured source, with said means comprising cosmetics, lotions, or body spray with a flavor of scent.

3. Objectives and Advantages

The objective of this invention is communication, and emission, of scent, by means of a computer or phone machine-device, and communication and emission of scent by means of a ScentDEV in connection to said machine-device. A further objective is presenting enhancements in communication, and emission, of scent, with means of ScentCOM. The said enhancements are performed with means of a ScentCOM system or process, comprising, scent communication, and emission, by means of a said scent-device in connection to a said machine-device.

The scent emission system or process comprises scent information, inputted by a user or client, or present on a machine-device, client, server, or host. The said scent emission system or process comprises of, an external machine-device connection to, and internal connections within, said scent-device.

A further objective of this invention is communication, and emission, of scent, for enhancing the communication system or process of a computer or phone machine-device, with the additional element of scent. The said enhancement presents to a user or client, the necessary scent element for communication, and performance emission of scent. The communication, and emission, of scent, enhances the quality of the said communication process, by means of a said machine-device. It enhances the communication system or process, by means of presenting to a user or client, the additional element of scent in communications, with the objective for perception of scent therein, comprising, of real-life events.

A utility of the ScentCOM system or process, comprises, the communication of scent, from a source of interest to a user or client, with means of a computer or phone program or application. A further utility of the said ScentCOM system or process is in advertising, marketing, or sale, of a product, or products, consisting of a flavor of scent. The communication, by means of a said machine-device, presents to a user or client a ScentCOM system or process, with coverage of usage spanning the networked globe.

The objective of a related invention, namely, the Mobile ScentDEV, is in presenting to a user or client, a device that performs emission of scent, by means of user or client controls on said device. The said device is compact, travel friendly, and performs emission of fresh scent on control selections, or settings, of a user or client.

The additional features of said Mobile ScentDEV, comprise, user or client controls for robust and flexible operation, reuse of the said device, and a compact embodiment for possession on a user or client.

The enhanced features of the said Mobile ScentDEV is reuse, refill, and recycle, of the source of scent thereon, user or client programmability of the rate of emission or intensity of scent therefrom, and controls for selection, or setting, of a flavor of scent for emission therefrom. The said Mobile ScentDEV is most suitable for use, while in possession of a user or client.

### SUMMARY OF THE INVENTION

The system or process of this invention, namely ScentCOM, is the communication, and emission, of scent, by means of a computer or phone machine-device; and communication and emission of scent by means of, a ScentDEV in connection to a said machine-device, or a mobile personal scent device or Mobile ScentDEV.

The products of this invention comprise hardware, software, and hybrid, ScentCOM system or process parts, components, and sub-systems, for enhancing the said system or process. The said products enable enhancements of ScentCOM, for employment in asynchronous or real-time communications.

The additional new scent-device, the Mobile ScentDEV, has usages in performance emission of scent, comprising, while in possession on a user or client.

An important aspect of this invention is communication of the additional element of scent, by means of a said machine-device, namely, a standalone or networked computer, or a phone. The scope of this invention, comprises, user or client communications, and usages of ScentCOM for personal, business, and professional purposes.

A further achievement is in presenting new scent-devices for scent communication, and emission, namely, a ScentDEV, and a Mobile ScentDEV, wherein, the said “ScentDEV” comprises a PM-ScentDEV, and E-ScentDEV, defined herein below.

The ScentDEV performs emission of scent on scent information communicated thereto, by means of a machine-device, whereas, the Mobile ScentDEV performs emission of scent, on user or client control selections or settings on a said device. The said ScentDEV comprises both, internal, and external, communications for performance emission of scent by means of said scent-device. The said Mobile ScentDEV comprises, internal communications, and external communications, comprising user or client input onto said scent-device.

The ScentCOM system or process for communication, and emission, comprises an optional scent controller, referred to herein as “ScentCNTRLR”. The said ScentCNTRLR is either external to, or internal on, a said ScentDEV. The external ScentCNTRLR is a part, component, or subsystem, in the connection between a machine-device and a ScentDEV, whereas, an internal ScentCNTRLR is a part, component, or subsystem on a said ScentDEV. The ScentCNTRLR acts as a buffer, and safety device, subjecting limitations on emission from said ScentDEV.

The ScentCOM system or process, by means of scent data communication, presents to a user or client, the necessary communication element, for performance emission of scent by means of a ScentDEV. The said ScentCOM system or process enhances the quality of communication, to the level of real-life events.

Herein following, is a brief summary on usages of the ScentCOM system or process, by means of a standalone or networked computer, a phone, and a Mobile ScentDEV. The said usages are, however, not a limitation of the ScentCOM system or process, the ScentDEV, nor the Mobile ScentDEV.

The utility, and selected usage, of the ScentCOM system or process comprises the following:

(1) Standalone Computer: A standalone computer, as defined herein, is a computer not connected to a communication network, comprising of the internet. The said standalone computer employs the ScentCOM system or process, for communication, and emission, of scent, by means of a connection to a ScentDEV. The said standalone computer performs emission of scent, for usages comprising personal, business, and professional purposes.

The personal usages of ScentCOM, comprise, programs or applications that process, and communicate, scent information read or received by means of a user or client input, electronic storage device, or a computer host, comprising scent communication data. The said processed scent information is communicated to a ScentDEV for performance emission of scent, with means comprising of a ScentDEV driver. The said ScentCOM system or process is employed in performing emission of scent, by means of a ScentDEV, to the atmosphere surrounding the said ScentDEV comprising the like of a cubicle, or room.

The business usages of ScentCOM comprise, sampling of a product, or products, with a flavor of scent. A sample may comprise a flavor of perfume for testing, or selection, employed in adverting, marketing, or sale, of a product, or products, with a flavor of scent.

The professional usage of ScentCOM, comprise, a program or application that communicates scent information for performance emission of scent. The other professional usages, comprise, memorabilia that employs a computer for usage, comprising the like of a soft copy of a greeting, an autobiography, or an interview.

The said usages, comprise, performance emission of scent, during usage of a program or application with means of a said computer. The said program or application, comprises, the like of a document, “image content” such as a party, graduation, or wedding, and a computer gaming program or application.

A further usage is performing emission of scent, during performance output, comprising the likes of text, sound, image, and moving picture, by means of a computer.

The said examples explain the utility, and usages, of the ScentCOM system or process by means of a standalone computer in connection to a ScentDEV.

(2) Networked Computer: A networked computer, as defined herein, is a computer connected to a communication network, comprising the internet. The objective of the ScentCOM system or process, by means of a networked computer, is communication of scent information by means of a network communication channel, and, communication and emission of scent, by means of a ScentDEV in connection to a networked computer.

The communication, and emission, of scent, by means of a networked computer, is similar to that of a standalone computer, with the additional processes for, reading or receiving, and writing or transmitting, scent information by means of a network communication channel. The said scent information, after being read or received by the said networked computer, is communicated to a ScentDEV in connection thereto, with means comprising of a ScentDEV driver. The said ScentDEV, upon reading or receiving the said ScentDEV driver communicated scent information, performs emission of scent therefrom.

The usages of the ScentCOM system or process, by means of a networked computer, comprise, said usages by means of a standalone computer, and additional usages gained by employing scent information communication, with means of a network communication channel. The network ScentCOM therefore, presents to a user or client, access to scent information by means of a communication network, for personal, business, and professional purposes.

One of the usages of network ScentCOM is in user or client communications, with means of a network communication channel, comprising scent information reception from, or transmission to, another user or client. The said scent information is communicated by means of a wireline or wireless connection, to another user or client, in, or during, communication. The said scent information is pre-programmed on, resides in, or communicated to, the communicating user or client's OS, program, or application.

A further usage of network ScentCOM is in advertising, marketing, or sale of products comprising of a flavor of scent. An example of said usage is in presenting to a user or client, a flavor of scent, comprised in cosmetics, food, spirit, and the like.

The said usages, with means employing a network communication channel, presents to a user or client, a convenient, economical, and centralized forum, for advertising, marketing, or sale, of a product, or products, with a flavor of scent, from a one-stop-shop location.

The said illustrations encompass consumer, business, and professional usages of network ScentCOM, with means of a network communication channel. The aforesaid usages are a barebones illustration, of the network ScentCOM system or process, by means of a networked computer. The aforesaid examples are, however, not a limitation of network ScentCOM by means of a networked computer in connection to a ScentDEV.

(3) Phone: A phone machine-device performs emission of scent, by means of a connection to a ScentDEV. The said phone communicates scent information to a ScentDEV, with means comprising of a ScentDEV driver. The said phone activates, or deactivates, a ScentDEV, and performs emission of scent therefrom on scent information communicated from said phone. The said scent information is communicated to said phone, by means comprising of, a timer, a specific usage of said phone, or a reception of a particular call.

The phone comprises a clock, means with which a user or client programs performance emission of scent. A phone in connection to a ScentDEV may be used similar to an alarm clock, for time-based performance emission of scent.

A feature of ScentCOM by means of a phone in connection to a ScentDEV, is performance emission of scent on a particular call, as identified with means of a caller id comprising said phone. A further feature of ScentCOM is where a said phone performs emission of scent, on a specific usage of said phone, such as, a user or client initiated phone call, listening to voicemail, or receiving a call from another user, client, or machine-device.

An enhancement of the ScentCOM system or process, by means of a phone, is the process of reading or receiving scent information during a phone call, from the calling machine-device, client, or user.

(4) Mobile ScentDEV: A “Mobile ScentDEV” is a mobile personal scent device. The said device comprises user controls for operation of the said device. The embodiment of said device, comprises of, mechanical, electro-mechanical, or electrical user controls. The ScentCOM system or process for communication, and emission, of scent, by means of a Mobile ScentDEV is independent of any other machine, apparatus, or device.

The operation of the Mobile ScentDEV is controlled by means of user or client controls embodying said device. The activation, deactivation, and event based or circumstantial operation, of said device, is facilitated by means of said user or client controls. The said means comprise functional, timing, and performance controls for said device. Another feature is user or client programmability of the said Mobile ScentDEV.

A further feature of the Mobile ScentDEV, comprises, user or client controls for selecting, or setting, of the rate of emission or intensity of scent from said device. A further feature is controls for selecting a flavor of scent, from more than one flavor, for emission from said device. The said device comprises features for the reuse, refill, and recycle, of the source of scent embodying said device.

A Mobile ScentDEV has numerous usages. The said device is suitable, and efficient, for usage, while in possession of a user or client. The said device is also capable of being carried in a hand bag, placed in a room or cubicle, or ported onto a transport mobile, for performance emission of scent. The Mobile ScentDEV is a compact, convenient, and mobile friendly device.

### BRIEF DESCRIPTION OF THE DRAWINGS

The objectives of this invention will become more apparent, and the invention best understood from the following description of the ScentCOM system or process, when read in reference to the accompanying drawings, wherein:

FIG. 1 illustrates a standalone computer in connection to a ScentDEV.

FIG. 2 illustrates a system diagram of FIG. 1 for performance emission of scent.

FIG. 3 illustrates a one-way ScentCOM, by means of a computer communication network.

FIG. 4 illustrates a two-way ScentCOM, by means of a communication network.

FIG. 5 illustrates a networked computer in connection to more than one ScentDEV.

FIG. 6 illustrates a ScentDEV with an external ScentCNTRLR.

FIG. 7 illustrates a ScentDEV with an integrated ScentCNTRLR.

FIG. 8 illustrates a wireless ScentDEV, with an integrated ScentCNTRLR.

FIG. 9 illustrates a ScentDEV consisting of more than one flavor of scent.

FIG. 10 illustrates a Mobile ScentDEV with mechanical user controls.

FIG. 11 illustrates a Mobile ScentDEV with electro-mechanical user controls.

FIG. 12 illustrates a Mobile ScentDEV with electronic user controls.

FIG. 13 illustrates a Mobile ScentDEV, with a feature for selecting a flavor of scent for emission.

### DESCRIPTION OF THE SYSTEM OR PROCESS

This invention pertains to the communication, and emission, of scent. The word “communication” as defined herein, comprises forward, and reverse, user-machine, user-client, and user-user communications within the scope of this invention. The said word, communication, further comprises forward, and reverse, machine-client, and machine-machine, communications within the scope of the specification.

A user-machine communication is established, when a user interacts with a machine-device or scent-device.

A user-client communication is established, when a user interacts with a client program or application, on, or by means of a machine-device or scent-device.

A user-user communication is established, when a user interacts with another user, by means of a machine-device, with means of a network communication channel. A user-user communication is therein established, between a computer user and another computer user, a phone user and another phone user, a computer user and a phone user, or a phone user and a computer user.

A machine-machine communication is established, comprising, when a machine-device communicates with another machine-device, a scent-device, or internally therewithin, and further comprising, when a scent-device communicates with a machine-device, or internally therewithin.

The word “emission” as defined herein, is performance emission of scent, by means of a scent-device, comprising, a ScentDEV, or a Mobile ScentDEV, within the scope of this invention.

The ScentCOM system or process is the communication, and emission, of scent, by means of a computer-ScentDEV, phone-ScentDEV, Mobile ScentDEV, or other ScentDEV. The said computer or phone employs the ScentCOM system or process, to read or receive scent information from a user or client input, an electronic storage device, or a machine-device host. The said read, or received, scent information is thereof communicated, from said machine-device to a ScentDEV, for performance emission of scent, with means comprising of a ScentDEV driver. The said ScentDEV driver is pre-, or device plug-in-, installed onto said machine-device that is in connection to a ScentDEV.

However, when a ScentCNTRLR is present on, or the connection from a said machine-device to a ScentDEV, the read or received scent information is instead communicated directly to a ScentCNTRLR, with means comprising of a ScentDEV driver. The said read or received scent information is processed by means of the said ScentCNTRLR, with control settings thereon, and communicated to the said ScentDEV for performance emission of scent.

The ScentCNTRLR, may alternatively comprise regulating incense emission from a ScentDEV. The words ‘scent’, and ‘incense’, are interchangeable in the specification herein.

The analogy of the ScentCOM system or process is the communication, and performance playing, of sound, by means of a speaker in connection to a machine-device.

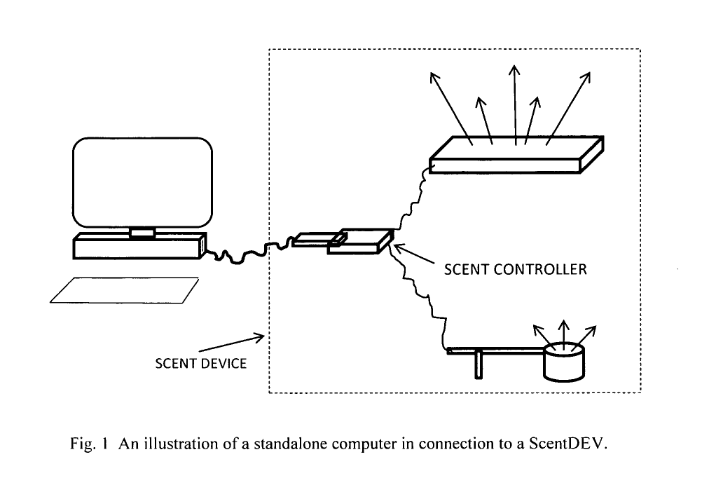

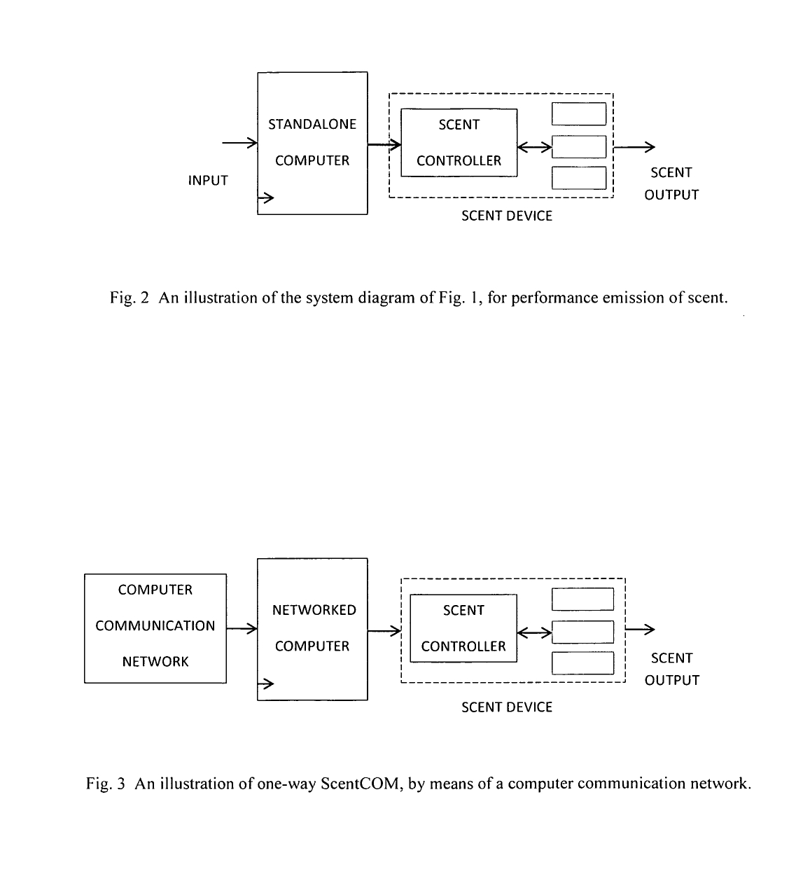

FIG. 1 illustrates a standalone computer in connection to a ScentDEV. The said figure shows a ScentCNTRLR present in the connection between said standalone computer and ScentDEV. The said ScentDEV performs emission of scent, upon scent information communicated from said standalone computer machine-device, with means comprising of a ScentDEV driver.

FIG. 2 illustrates the ScentCOM system diagram of FIG. 1 for communication, and emission, of scent, by means of said standalone computer.

Having illustrated the ScentCOM system or process for a standalone computer, the illustrated drawings present the ScentCOM system or process for a networked computer.

FIG. 3 illustrates the ScentCOM system or process for one-way scent communication, with means of a communication network. Here, a networked computer receives scent information from a networked host, with means of a network communication channel. The said network computer received scent information is thereof communicated to a ScentDEV in connection thereto, with means comprising of a ScentDEV driver. The said ScentDEV, upon reading or receiving the said scent information, performs emission of scent therefrom, similar to the ScentCOM system or process for performance emission of scent, by means of a standalone computer.

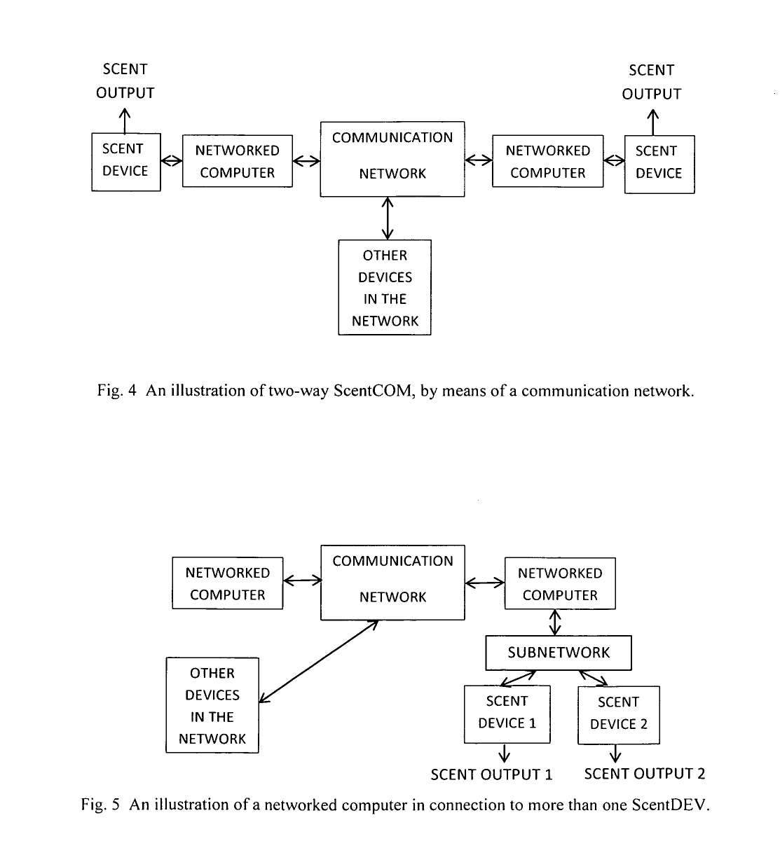

FIG. 4 illustrates the ScentCOM system or process, for two-way scent communication, by means of a communication network. The communication system or process, in the said figure, is capable of two-way communication of scent information, with means of a network communication channel. The said two-way communication is performed by means of, reading or receiving scent information from, and writing or transmitting scent information to, a machine-device, client, server, host, or another user, with means of said network communication channel.

The said communication network comprises machine-devices, and scent-devices, comprising computers, phones, and other electronic devices in the said network. The said network additionally comprises sub-networks in connection thereto. The said sub-network comprises a Personal Area Network or “PAN”, or other sub-network. The said figure shows networked electronic devices, in the said system or process, comprising computers, phones, and other wireless devices.

FIG. 5 illustrates a system or process for communication, and emission, of scent, by means of more than one ScentDEV in a network. Here, a networked computer is in connection to more than one ScentDEV, with means of a network or sub-network. A networked machine-device communicates to a said networked computer, another machine-device, or a scent-device, comprising said network, with means of a network communication channel. The said network comprises a Local Area Network or “LAN”, a Personal Area Network or “PAN”, or other network for communication, and emission, of scent, by means comprising of a networked ScentDEV. The said figure shows a networked computer, in connection to a sub-network, consisting of ScentDEV1, and ScentDEV2.

A networked computer communicates scent information to a networked ScentDEV, with means comprising of a network ScentDEV driver. The said computer communicates scent information, to more than one ScentDEV in a network, for independent, or coordinated, performance emission of scent, therefrom, with means comprising of a said network ScentDEV driver.

The said network scent information communication is additionally employed, by means of a remote networked computer. A remote networked computer communicates scent information directly to a networked ScentDEV, with means of a network communication channel, for performance emission of scent therefrom.

A networked computer in connection to more than one ScentDEV, is similar to a networked computer in connection to more than one speaker, with the said speaker performance playable, either, independently, or in coordination. A further similarity exists, in the case of a networked computer in connection to more than one networked printer, with means to pre-assign, or assign, a print job.

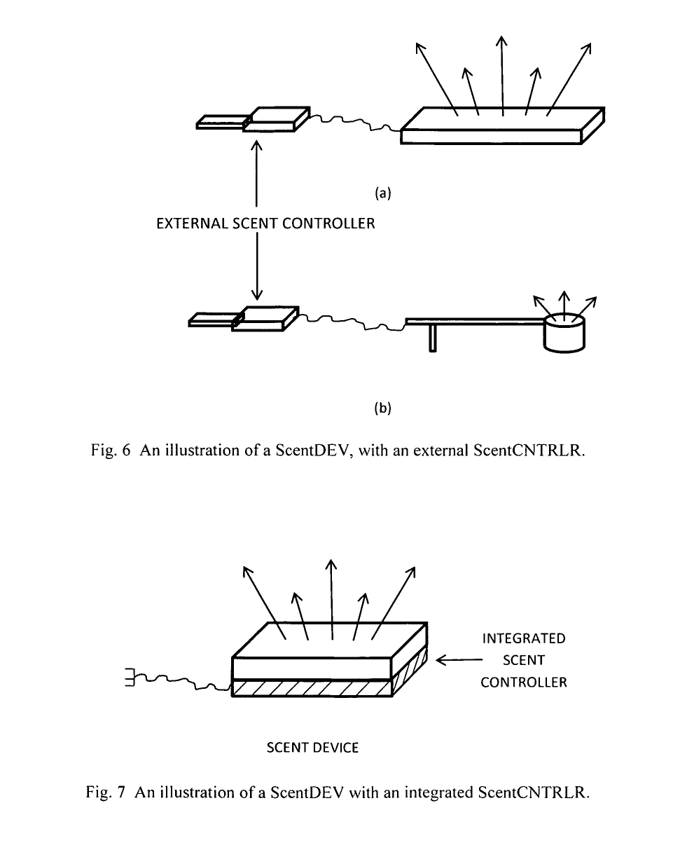

FIG. 6 illustrates a more detailed view of an external scent controller in connection to a ScentDEV. Here, a computer or phone machine-device connects to a ScentDEV, by means of the said external ScentCNTRLR, present in the connection between said machine-device and said ScentDEV. The said machine-device communicates to the external ScentCNTRLR scent information from said machine-device, with means comprising of a ScentDEV driver. The said read or received scent information, is processed by means of said ScentCNTRLR with control settings thereon, and communicated to the said ScentDEV for performance emission of scent.

FIG. 7 illustrates a ScentDEV with an integrated ScentCNTRLR. The said integration follows technology trend in integrating parts, components, and subsystems, to make the system or process more efficient. The said figure shows a ScentDEV with a port connector, employed in connecting the said ScentDEV to a machine-device.

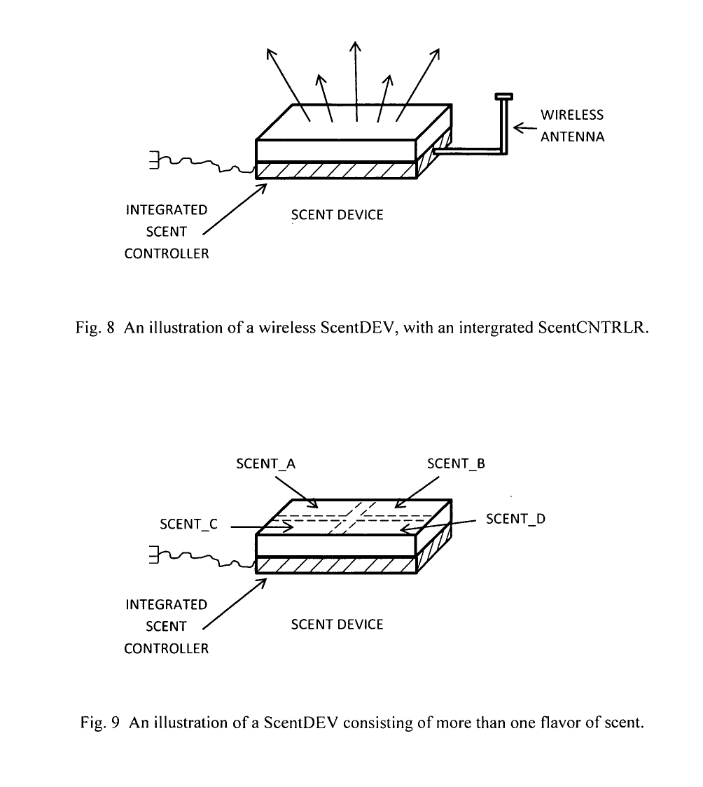

FIG. 8 illustrates a wireless ScentDEV. A wireless ScentDEV consists of a wireless antenna receiver, for receiving scent information from a machine-device broadcast. The said scent information is communicated from a machine-device to a said wireless ScentDEV for performance emission of scent, with means comprising of a wireless ScentDEV driver, means with a wireless communication channel.

A wireless ScentDEV may additionally comprise a transmitter, for control, communication, and coordination, of the said wireless ScentDEV. A wireless ScentDEV with a transmitter, in contrast to without a transmitter, reads scent information with means of a wireless communication channel, in addition to receiving scent information communicated from a machine-device in connection thereto.

FIG. 9 illustrates a ScentDEV with more than one flavor of scent emission capability. The scent information on an OS, program, or application, on a machine-device, is communicated to a ScentDEV in connection thereto, for performance emission of a flavor of scent, from more than one flavor, communicated therefrom. The said figure shows flavors of scent, named, Scent_A, Scent_B, Scent_C, and Scent_D, on said ScentDEV with an integrated ScentCNTRLR.

The ScentCOM system or process, uses scent information inputted into, present in, or accessed by, a machine-device. The said scent information is read, or received, with means of a scent information program or application on said machine-device. The said scent information program or application, thereof, uses the said read or received scent information for performance emission of scent, by means of a ScentDEV, or for storing comprising saving the said scent information on a user or client program, application, machine-device, or a networked host.

The ScentCOM system or process for scent information communication, is employed by means comprising of a program or application, similar to e-mail used for text communication, with means of the internet or other communication network; and voice or sound communication, by means of a computer or phone machine-device. The said scent information is communicated with means of a network communication channel, between a user and client, or between users.

The system or process for communication, and emission, of scent, by means of a machine-device in connection to a ScentDEV, is similar to communication of, and performance playing, voice or sound, by means of a machine-device in connection to a speaker.

An advancement of the system or process of this invention is reading, or sensing, scent information directly from the atmosphere surrounding a reader, or sensor. The said read, or sensed, scent information, is thereof used by the ScentCOM system or process for communication, and emission, of scent.

A ScentDEV receives the necessary operational power, by means of a power source in connection thereto. The said power source is facilitated with means of a power supply, from the machine-device in connection to a ScentDEV. A power source to a ScentDEV may alternatively be supplied, with means of a standalone battery, or plugging a power adapter into an electrical outlet.

The illustrations presented herein are, however, not a limitation of the ScentCOM system or process, the ScentDEV, nor Mobile ScentDEV, wherein the embodiment comprises all designs within specification of this invention.

### Mobile ScentDEV

The Mobile ScentDEV is a mobile personal scent device. The said device is functionally efficient in performance emission of scent, while in possession of a user or client. The features of said Mobile ScentDEV, comprise, a compact lightweight embodiment, and user or client controls for operation of said scent-device.

The process for communication, and emission, of scent, by means of a Mobile ScentDEV, is somewhat similar to that of a ScentDEV. However, a Mobile ScentDEV, in contrast to a ScentDEV, is an independent device in embodiment, and operation. The said device comprises user or client controls that are manual, or programmable. The performance of said device is user or client controlled, whom, by means of said controls subjects operational selection, or setting, for performance emission of scent therefrom. The said device is operated by means of mechanical, electro-mechanical, or electrical user controls, with an optional feature for programmability.

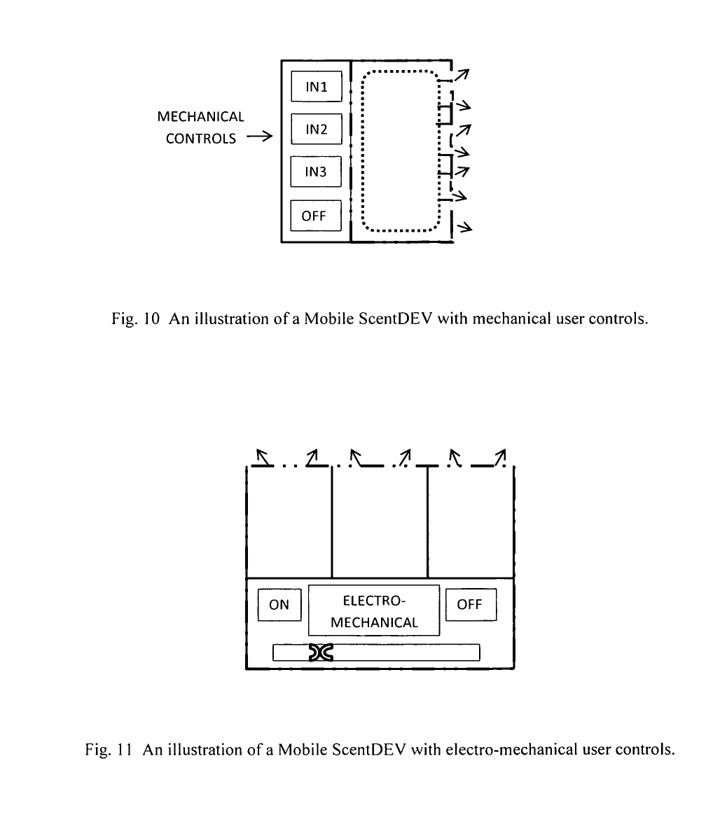

FIG. 10 illustrates a Mobile ScentDEV consisting of mechanical user controls. The said device is operated by means comprising of said mechanical controls for activation, deactivation, and controlling performance emission of scent therefrom. A user or client operation on said controls, effectuate control in communication, and emission, of scent from a said device. An enhancement of the said device is user or client controls for selecting, or setting, of the rate of emission or intensity of scent from said device. The said figure shows a feature with mechanical user controls, namely, IN1, IN2, and IN3, respectively corresponding to low, medium, and hi, rate of emission or intensity of scent from said device.

FIG. 11 illustrates a Mobile ScentDEV consisting of electro-mechanical user controls. The said device is operated by means comprising of said electrical, mechanical, and electro-mechanical controls for activation, deactivation, and controlling performance emission of scent therefrom. The said figure shows electro-mechanical controls for switching said device on, off, or in pausing. The said figure also shows mechanical controls, adjacent to said electro-mechanical controls, for selecting or setting of the rate of emission or intensity of scent from the said device.

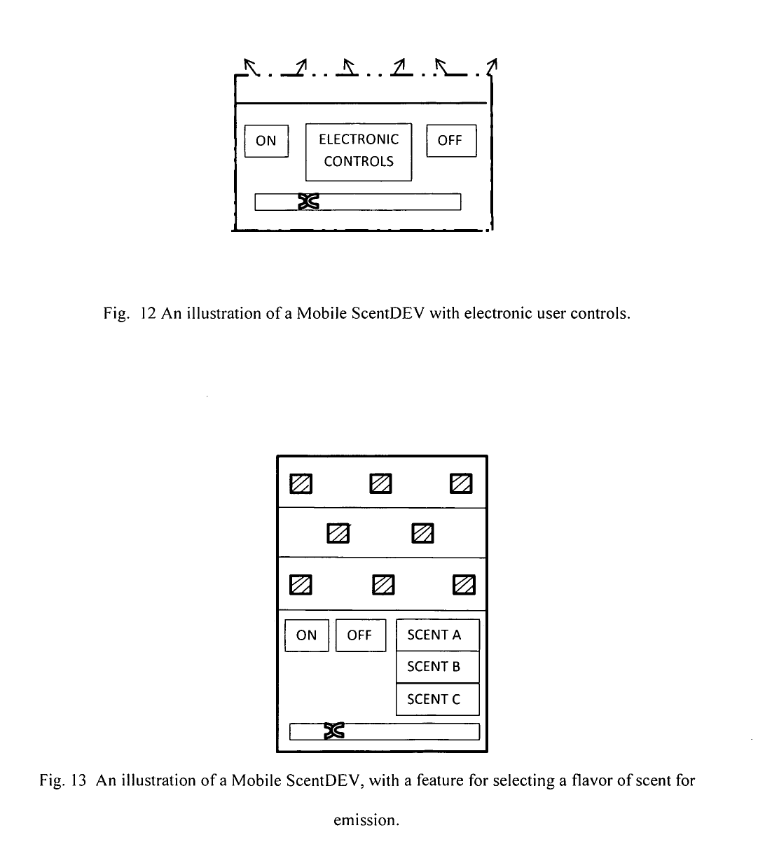

FIG. 12 illustrates a Mobile ScentDEV consisting of electrical, comprising electronic, user controls. The said device is operated by means comprising of said electrical controls for activation, deactivation, and controlling performance emission of scent therefrom. The said figure shows electronic controls for switching said device on, off, or in pausing. The said figure shows a display of said device performance during operation, adjacent to said electronic controls. The display of said device performance, comprises, operational information on the amount of scent remaining on, and the rate of emission or intensity of scent from, the said device.

FIG. 13 illustrates an advanced Mobile ScentDEV. The said device consists of user controls for selecting a flavor of scent, from more than one flavor, for emission from said device.

A Mobile ScentDEV comprises a power source, as a source of power for the said device. The said power source is facilitated with means of a battery, or sharing a power source of another device in possession of said user or client.

The illustrations presented herein are, however, not a limitation of the invention, wherein, the Mobile ScentDEV is any embodiment that is compact for possession on a user or client.

Scent Information Communication: The system or process for communication of scent, with means of a network communication channel, in the absence of a network communication protocol, or standard, for the said scent information communication, is facilitated with means of scent data communication. The said scent data communication comprises transmitting, and receiving, “scent communication data”, with means of a network communication channel. The system or process for communication of scent information, by the said process means, is presented in more detail, herein following:
Transmit: A user or client writes or transmits scent information to another networked machine-device, client, server, or host, with means of a network communication channel. The said user or client employs scent information present in, accessed by, or instantly input into, the said user or client's (1) OS settings, (2) program settings or input, (3) application settings or input, (4) a GUI selection, or (5) a default setting of null, in said writing or transmitting communication.

The said scent information is processed before, or during, transmission communication, with means of data mapping the said scent information into “scent communication data”. The said transformed scent communication data is used by a said networked machine-device, for writing, or transmitting, the said data to another networked machine-device, client, server, or host, with means of a network communication channel.

The said networked machine-device, client, server, or host, performs reverse data mapping, on the received “scent communication data”, whereby obtaining the, reverse transformed, originally transmitted, scent information. The said received and reverse transformed scent information, is thereupon internally written, or transmitted, to an OS, program, or application, of the receiving user or client.

Receive: A user or client reads or receives scent information, from another machine-device, client, server, or host, with means of a network communication channel. The said scent information originating from an OS, program, or application, of the transmitting user or client, is read or received by the receiving user or client.

The said read or received scent information is processed during, or after, receiving communications, with means of reverse data mapping the read or received “scent communication data” into scent information. The said reverse transformed scent information, is thereupon, internally written or transmitted, comprising saving, to said receiving user or client's (1) OS settings, (2) program settings or input, (3) application settings or input, (4) a GUI reception, or (5) a default setting of null, for performance emission of scent by means of a ScentDEV.

Communication and Processing: The said communication of scent information, comprise, (1) reading or receiving scent communication data from, and (2) writing or transmitting scent communication data to, a machine-device, client, server, or host, with means of a network communication channel. The said communicated scent information, is electronically processed, and communicated to an OS, program, or application, for usage, and storing, with storing means comprising saving, and performance emission of scent by means of a ScentDEV.

Herein following is a summary of the ScentCOM system or process, by means of a standalone or networked computer, a phone, and a Mobile ScentDEV.

(1) Standalone Computer: A standalone computer reads or receives scent information by means of a user or client input, an electronic storage device, or a machine-device host. The said scent information is employed with means of a user or client OS, program, or application, on said standalone computer.

A standalone computer is comprised of a wireline or wireless connection to a ScentDEV. The said standalone computer communicates scent information to a ScentDEV, by means of a connection thereto, with means comprising of a ScentDEV driver. The scent information so read or received by the said computer is communicated to a ScentDEV for performance emission of scent, with means comprising of a ScentDEV driver.

(2) Networked Computer: A networked computer reads or receives scent information, by means of a user or client input, an electronic storage device, or a machine-device, client, server, or host. The said networked computer employs the means of a communication network, comprising of the internet, for scent information communication.

The said networked computer, reads or receives scent information, comprising, from, and writes or transmits scent information to, another machine-device, or said machine-device client, server, or host, with means of a network communication channel.

The said network computer read, or received, scent information, is processed for usage, and storing, with storing means comprising saving, on said machine-device, client, server, or host, and used by a user or client OS, program, or application. The said networked computer communicates the read, or received, scent information to a ScentDEV, for performance emission of scent, with means comprising of a ScentDEV driver.

A networked computer is in connection to a ScentDEV, similar to a standalone computer in connection to a ScentDEV. The performance emission of scent, by means of a networked computer in connection to a ScentDEV, is similar to performance emission of scent, by means of a standalone computer in connection to a ScentDEV, with additional capability of communicating scent information, by means of a network, to a networked ScentDEV.

(3) Phone: A phone machine-device is in connection to a ScentDEV, by means plural. A phone machine-device connection to a ScentDEV, is similar to a phone machine-device connection to an external caller id device, or a DSL router.

A phone machine-device, communicates scent information to a ScentDEV, with means of a connection thereto, with means comprising of a ScentDEV driver. The said ScentDEV driver is pre-, or device-plugin, installed onto said phone machine-device, by means of said connection to a said ScentDEV.

The said ScentDEV, upon reading or receiving scent information directly from said phone machine-device, or a ScentCNTRLR present in the connection between said phone machine-device and said ScentDEV, performs emission of scent therefrom.

An enhancement of the ScentCOM system or process, by means of a phone machine-device, is enablement of transmission, and reception, of scent information during communication, by means of a phone, computer, hybrid, or other, network, with means of a network communication channel. The said phone machine-device, on reading or receiving said network communicated scent information, performs emission of scent by means of a ScentDEV in connection thereto.

(4) Mobile ScentDEV: A Mobile ScentDEV is a unique device, in that, the performance emission of scent from said device, is independent of any other device, apparatus, or machine.

A user or client operates a Mobile ScentDEV, by means of user or client controls embodying said device. The said device performs emission of scent, on control selections, or settings, of a user or client. The said controls function similar to a ScentCNTRLR, in regulating emission from said scent-device. The said device comprises an additional feature for user or client programmability, for emission of scent therefrom.

An enhanced feature of the Mobile ScentDEV is in presenting user or client controls, for selecting, or setting, of the rate of emission or intensity of scent from said device.

The additional features of a Mobile ScentDEV, comprise, (1) recycling of a said scent-device, by means comprising of changing or supplying the receptacle, canister, or container consisting the source of scent, (2) selectivity by the user or client, of the flavor of scent for emission from said scent-device, facilitated by means of loading one (with more than one flavor of scent), or more than one, scent receptacle, canister, or container onto said scent-device, and (3) reuse of the source of scent, by means of refilling the scent receptacle, canister, or container with a scent substance, similar to refilling of lighter fluid or gas, or change of an accessory, part, or component, similar to a coffee filter.

Enhancements to ScentCOM: The ScentCOM system or process, by means of a networked computer or phone, enhances networked systems, and processes, with means of presenting to a user or client, the additional element of scent in network communications. The said ScentCOM system or process requires enhancements in network operating systems, programs, and applications, for facilitating said communications, comprising the additional element of scent in network communications.

A further enhancement of ScentCOM is introduction of a computer, or phone, connectable ScentDEV that is portable, or mobile, referred to herein as “PM-ScentDEV”. The said portable, or mobile, PM-ScentDEV performs emission of scent, on scent information read or received from a machine-device. The said scent-device is suitable for usage, especially with a portable, or mobile, machine-device.

The performance emission of scent, from said PM-ScentDEV, is similar to communication, and emission, of scent, by means of a machine-device in connection to a ScentDEV. The said portable, or mobile, ScentDEV performs emission of scent, on scent information communicated from a machine-device in connection thereto, with means comprising of a ScentDEV driver.

A further enhancement of ScentCOM is introduction of an electronically programmable scent-device, referred to herein as “E-ScentDEV”. The said E-ScentDEV, a consumer product, is a pre-programmed, programmed, or programmable, scent-device, comprising network adaptability for independent, or coordinated, performance emission of scent.

The E-ScentDEV is either, pre-programmed, or user or client programmed, with scent information, for performance emission of scent from a said device. The said E-ScentDEV comprises usages in a home, office, business, or transport mobile.

The said PM-ScentDEV, and E-ScentDEV, are encompassed, within the definition of a computer in connection to a ScentDEV, within scope of this invention.

I claim:

1. A system or process for communication, and emission, of scent, by means of a computer or phone.

2. A device, apparatus, or machine of claim 1, with means for communication, and emission, of scent, namely a ScentDEV.

3. An element, component, or part of claim 2, comprised in, or for use with, said ScentDEV.

4. A scent device, apparatus, or machine of claim 2, employing the means of a battery.

5. An OS, program, or application of claim 1 that enables communication, and emission, of scent.

6. An OS, program, or application, of claim 1, for asynchronous or real-time, communication, and emission, of scent, with performance output combination comprising, text, hyperlink, sound, image, and moving picture.

7. A system or process for emission of scent, by means of a user or client controlled, mobile personal scent device.

8. A device, apparatus, or machine of claim 7, namely, a Mobile ScentDEV.

9. An element, component, or part of claim 7, comprised in, or for use with, said Mobile ScentDEV.

10. The said Mobile ScentDEV of claim 7, employing the means of a battery.
